(19) United States
(12) Patent Application Publication
(10) Pub. No.: US 2023/0337696 A1
(43) Pub. Date: Oct. 26, 2023

(54) ICE LOLLY FOR FILLING

(71) Applicant: Claudemir BOSCO, Araçatuba (BR)

(72) Inventor: Claudemir BOSCO, Araçatuba (BR)

(21) Appl. No.: 17/789,053

(22) PCT Filed: Sep. 9, 2020
(86) PCT No.: PCT/BR2020/050358

§ 371 Date: Jun. 24, 2022

(30) Foreign Application Priority Data
Jan. 10, 2020 (BR) 102020000649-5

(51) Int. Cl. A23G 9/48; A23G 9/50

(52) U.S. Cl. CPC A23G 9/485; A23G 9/503

(57) ABSTRACT

An ice lolly for filling, belonging to the food technical sector. The ice lolly has receptacles to receive the fillings chosen by the consumer. Consumers will buy the ice lolly, choose their preferred fillings, which may be packaged in different ways, and insert the fillings into the receptacles at the time of consumption. The ice lolly for filling comprises a solidified body, a stick that is inserted through a bottom side of the solidified body, and an upper side of the solidified body having at least one hole that forms a receptacle to receive fillings at time of consumption.

### FIELD OF THE INVENTION

The present invention relates to an ice lolly for filling up, belonging to the food technical sector. More particularly, it relates to an ice lolly with receptacles to receive the fillings chosen by the consumer. This creates an unprecedented way of consuming the ice lolly, wherein the consumer will buy the ice lolly, choose the preferred filling, which may be packaged in different ways, and insert the filling into the receptacles at the time of consumption.

### BACKGROUND OF THE INVENTION

An ice lolly is a solidified ice cream with various different shapes and sizes. It is often held by the end of a stick that is inserted through the bottom side of the ice lolly body.

Although the ice lolly body can have different shapes, it is commonly in the shape of a number “8”. The ice lolly usually has a solid body without fillings. In cases where the ice lolly contains fillings, the fillings are solidified and sealed inside the ice lolly body during its production. This neither allows for any variation in the fillings or form of consumption, nor allows for the fillings to have different temperatures than the ice lolly body.

Thus, consumers cannot combine their tastes and the combination of fillings launched by the industry. Consumers also cannot have different fillings with temperatures that differ from the ice lolly body. Hence, consumers are restricted to the traditional form of consumption described above.

Thus, an ice lolly for filling was developed. The ice lolly allows, through receptacles formed by holes, a wide variation of forms of consumption of the ice lolly, with the addition of fillings at different temperatures that are inserted into the receptacles at the time of consumption. The fillings can be liquids, solids, and granulates. Chopped fruits may even be inserted into the receptacles to further enhance the flavor of the ice lolly. Solid foods, such as chocolate, guava, cookies, and granulates, that are rod-shaped can also be inserted into the receptacles.

### BRIEF DESCRIPTION OF THE DRAWINGS

The ice lolly to be filled up will be better understood through the attached drawings that schematically represent:

FIG. 1—a perspective view of an ice lolly for filling;

FIG. 2—a top view of the ice lolly for filling;

FIG. 3—a front view of the ice lolly for filling;

FIG. 4—a side view of the ice lolly for filling;

FIG. 5—a perspective view of a form of consumption of the ice lolly for filling, wherein solid fillings in the form of rods are introduced;

FIG. 6—a perspective view of a form of consumption of the ice lolly for filling, wherein liquid fillings are introduced; and

FIG. 7—a perspective view of a form of consumption of the ice lolly for filling, wherein granulated fillings are introduced.

### DETAILED DESCRIPTION OF THE INVENTION

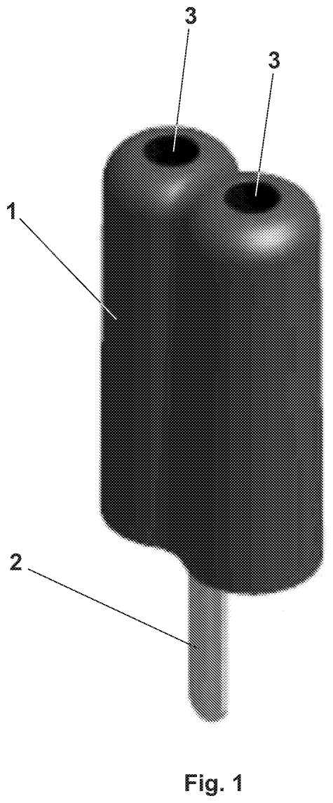

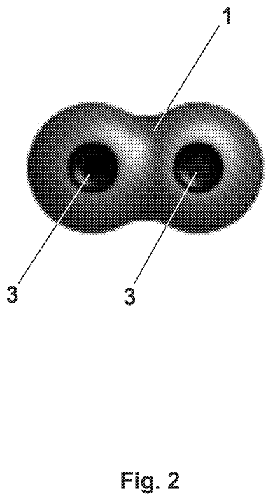

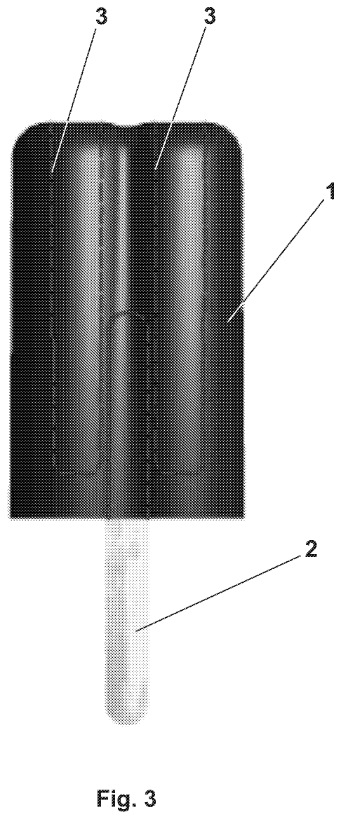

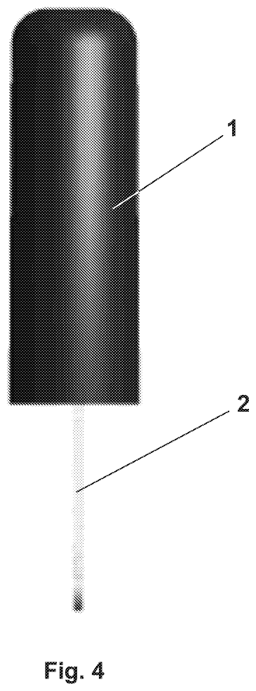

As seen in FIGS. 1 to 7, an ice lolly for filling comprises a solidified body (1), a stick (2) that is inserted through a bottom side of the solidified body (1), an upper side of the solidified body (1) having at least one hole (3) that forms a receptacle to receive fillings at time of consumption.

The at least one hole (3) can have, for example, a circular, elliptical, square, or rectangular cross-section, among other geometric shapes.

The fillings received by the at least one hole (3) that forms a receptacle can be liquid, solid or granulates.

The stick (2) can have various shapes. In at least one embodiment, the stick (2) is flat. This stick is commonly referred to as the “Flat Stick”.

In at least one embodiment, the ice lolly for filling comprises a solidified body (1) in the shape of a number “8”, having two holes (3) of circular section in its upper side, the two holes (2) forming two cylindrical receptacles with the stick (2) positioned in between the two holes (3).

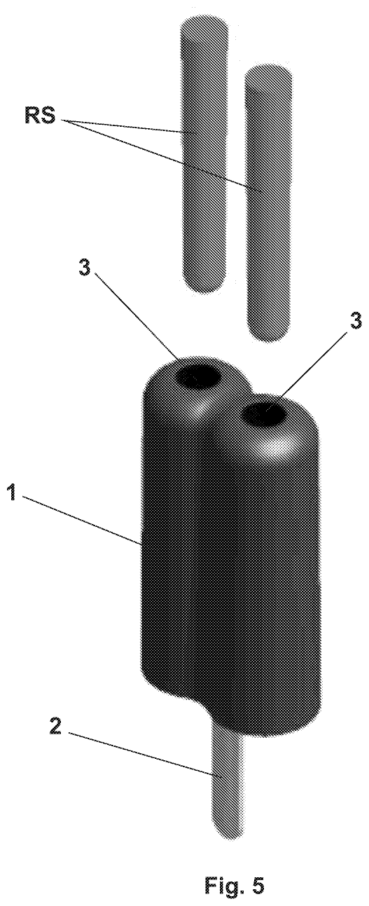

As seen in FIGS. 5 to 7, liquid, solid (rods) or granulated fillings of different textures and temperatures can be received by the receptacles formed by the holes (3).

FIG. 5 illustrates an example of the ice lolly for filling where solid fillings (RS), such as two chocolate rods, are introduced into the receptacles formed by the holes (3) of the solidified body (1) of the ice lolly.

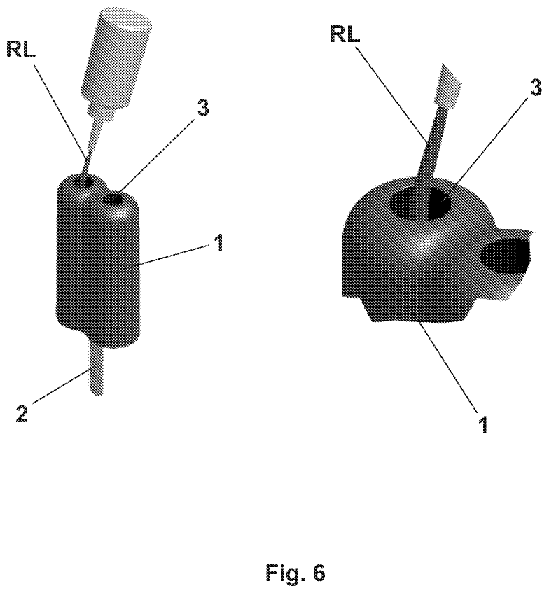

FIG. 6 illustrates an example of the ice lolly for filling where liquid fillings (RL), such as chocolate, are introduced into the receptacles formed by the holes (3) of the solidified body (1) of the ice lolly.

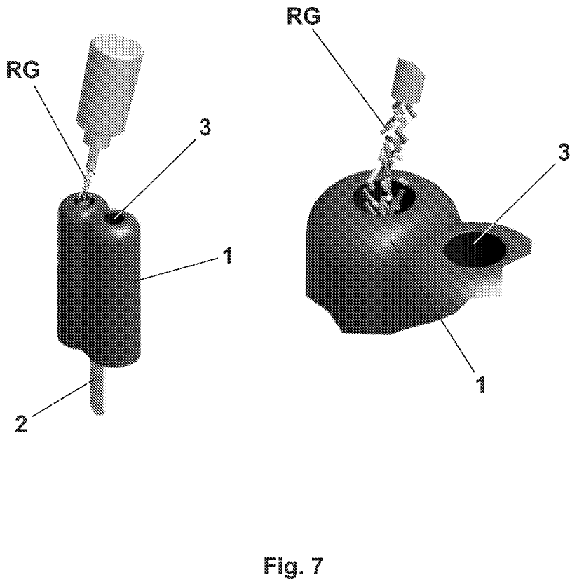

FIG. 7 illustrates an example of the ice lolly for filling where granulated fillings (RG), such as granulated chocolates, are introduced into the receptacles formed by the holes (3) of the solidified body (1) of the ice lolly.

With regard to marketing, the ice lolly for filling can be sold for consumption at home or at the place of sale where the different fillings will also be offered.

The ice lolly for filling therefore offers the following advantages compared to those known in the state of the art on the market:
the consumer can have different combinations of fillings inside the ice lolly body;
the fillings can have different temperatures, and can be liquid, solid or granulate; and
chopped fruits and rod-shaped solids may be inserted into the receptacles formed by the holes.

1-5. (canceled)

6. An ice lolly for filling, comprising a solidified body, a stick that is inserted through a bottom side of the solidified body, an upper side of the solidified body having at least one hole that forms a receptacle to receive fillings at the time of consumption.

7. The ice lolly according to claim 6, wherein the at least one hole has a circular, elliptical, square or rectangular cross-section.

8. The ice lolly according to claim 6, wherein the stick is flat.

9. The ice lolly according to claim 6, wherein the fillings are liquid, solid or granulates.

10. The ice lolly according to claim 6, wherein the solidified body is in a shape of a number “8”, having two holes of circular section on the upper side of the solidified body, the two holes forming two cylindrical receptacles with the stick positioned in between the two holes.
